(19) United States
(12) Patent Application Publication
(10) Pub. No.: US 2004/0191155 A1
(43) Pub. Date: Sep. 30, 2004

(54) Thermal process for reducing the concentration of dinitrogen difluoride and dinitrogen tetrafluoride in nitrogen trifluoride

(76) Inventors: Barry Asher Mahler, Glen Mills, PA (US); Mario J. Nappa, Newark, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/396,926

(22) Filed: Mar. 25, 2003

(51) Int. Cl. C01B 21/083; B01D 53/34

(52) U.S. Cl. 423/406; 422/168

(57) ABSTRACT

The concentration of undesirable impurities dinitrogen difluoride and dinitrogen tetrafluoride in a nitrogen trifluoride mixture are reduced by heating the mixture in the gas phase in a vessel with an inner wall selected from electropolished metal, ceramic alumina or sapphire, and recovering a nitrogen trifluoride product having reduced concentration of such impurities. The process is preferably carried out at a temperature of at least about 150° C. to about 300° C. and the vessel is preferrably free of packing and has a minimized ratio of the vessel interior surface area to vessel volume in the region of the vessel where the heating step is carried out. The process optionally may further include the step of contacting the inner wall of the vessel with a passivating composition comprising fluorine gas.

### BACKGROUND OF THE INVENTION

1. Field of the Invention.

The present invention relates to a thermal, gas phase process for reducing the concentration of impurities dinitrogen difluoride and dinitrogen tetrafluoride in a mixture of nitrogen trifluoride and said impurities.

2. Description of Related Art.

Various fluorine-containing compounds are utilized in manufacturing processes that plasma-etch silicon-type materials in order to fabricate semiconductor devices. A major use of nitrogen trifluoride is as a “chemical vapor deposition” (CVD) chamber cleaning gas in semiconductor device manufacture. CVD chamber cleaning gases are used to form plasmas which interact with the internal surfaces of semiconductor fabrication equipment to remove the various deposits that accumulate over time.

Fluorinated compounds such as nitrogen trifluoride used in semiconductor manufacturing applications as cleaning gases are more commonly referred to as “electronic gases”. Electronic gases having high purity are critical for such semiconductor device manufacture applications. It is known that even trace amounts of impurities in these gases that enter semiconductor device manufacturing tools can result in wide line width and thus less information per device. Moreover, the presence of these impurities, including but not limited to particulates, metals, moisture, and other halocarbons in the electronic gases, even when only present in the part-per-million level, increases the defect rate in the production of these high-density integrated circuits. As a result, there has been increasing demand for higher purity electronic gases, and an increasing market value for the materials having the required purity. Identification of offending components and methods for their removal consequently represents a significant aspect of preparing the fluorinated compounds for these applications.

Nitrogen trifluoride may be prepared by a variety of methods, such as that disclosed in U.S. Pat. No. 3,235,474. Nitrogen trifluoride obtained from most methods, however, contains relatively large concentrations of undesirable impurities, such as nitrous oxide, carbon dioxide, dinitrogen difluoride and dinitrogen tetrafluoride. Dinitrogen difluoride and dinitrogen tetrafluoride are particularly undesirable impurities in a nitrogen trifluoride electronic gas product. Under certain conditions and at relatively low concentration, these compounds can form unstable and even explosive compositions. Therefore, in order to obtain high-purity nitrogen trifluoride that is free from dinitrogen difluoride and dinitrogen tetrafluoride for use as an electronic gas, methods of removing such impurities are necessary.

There are a variety of methods known for reducing dinitrogen difluoride and other impurities in a nitrogen trifluoride product, ranging from chemical and thermal treatments, adsorption on zeolites, silica gel, and activated alumina. Silica gel and activated alumina have been disclosed as both adsorbents at low temperature and as reagents at elevated temperatures.

U.S. Pat. No. 5,183,647 discloses purification of nitrogen trifluoride containing dinitrogen difluoride by heating said nitrogen trifluoride at an elevated temperature in a vessel the inner wall of which is coated with a film of nickel fluoride. Vessels packed with a solid fluoride to form a packed bed are preferred to using an empty vessel. This reference discloses that when the inner wall of the vessel is made of a metal other than nickel, the metal fluoride film is often peeled off easily by heating and thereby the metal surface is exposed since the coating is weak and the adhesive strength to the metal wall surface is low.

U.S. Pat. No. 4,948,571 discloses a process to decompose dinitrogen difluoride present in a nitrogen trifluoride gas by heating the nitrogen trifluoride gas containing the dinitrogen difluoride impurity at a temperature of 150-600° C. in a metallic vessel the inner wall of which is lined with a solid fluoride.

U.S. Pat. No. 4,193,976 and No. 4,156,598 disclose a method for removal of dinitrogen difluoride from nitrogen trifluoride. The method involves heating the nitrogen trifluoride in the presence of a particulate metal capable of defluorinating dinitrogen difluoride, but inert to nitrogen trifluoride, to a temperature of from about 149-538° C. for a time sufficient to effect defluorination of the dinitrogen difluoride. The metal must be regenerated after some length of time in order to effect decomposition of the dinitrogen difluoride.

In the known literature, the preferred method for removal of dinitrogen difluoride from nitrogen trifluoride is by passing the nitrogen trifluoride through a reactor packed with materials thought effective for selective removal of dinitrogen difluoride. Said packing material needs to be periodically replaced due to deterioration or consumption upon use. The literature is silent as to the removal of dinitrogen tetrafluoride from a nitrogen trifluoride product as well as the potential for these nitrogen trifluoride purification processes themselves to produce dinitrogen tetrafluoride from the very nitrogen trifluoride being purified.

### BRIEF SUMMARY OF THE INVENTION

The present invention is a process for reducing the concentration of at least one impurity selected from dinitrogen difluoride and dinitrogen tetrafluoride in a mixture of nitrogen trifluoride and said at least one impurity, comprising: heating said mixture at a temperature of at least about 150° C. in the gas phase in a vessel with an inner wall selected from the group consisting of electropolished metal, ceramic alumina and sapphire, and recovering a nitrogen trifluoride product having reduced concentration of said at least one impurity.

The present inventors have discovered this process whereby impurities dinitrogen difluoride and dinitrogen tetrafluoride contained in nitrogen trifluoride gas are efficiently decomposed and their concentration reduced by holding the gas at an elevated temperature. Surprisingly, it has been discovered that reducing and/or removing of these impurities is most efficient when the gas contact with surfaces is minimized, such as where the vessel or container is empty and does not contain any type of packing material. Further, the present inventors have discovered that undesirable decomposition of nitrogen trifluoride product and production of further impurities is reduced where the surfaces the nitrogen trifluoride composition comes in contact with during such elevated temperature treatment are selected from electropolished metals, ceramic alumina and sapphire.

The present invention offers an further improvement over previous methods by requiring no reagent or supplemental packing material for removing the dinitrogen difluoride be added or replaced. The present inventors have surprisingly discovered that passing a gas product comprising nitrogen trifluoride at elevated temperatures through tubular reactors, the inner surface of which are made of sapphire, ceramic alumina, or electropolished metals such as stainless steel or nickel, can reduce the undesirable impurities dinitrogen difluoride and dinitrogen tetrafluoride to very low levels (e.g., levels below about 0.1 ppm-molar) while minimizing nitrogen trifluoride degradation and yield loss to undesirable dinitrogen tetrafluoride.

### DETAILED DESCRIPTION OF THE INVENTION

The present invention is a process for reducing the concentration of at least one impurity selected from the group consisting of dinitrogen difluoride (FN=NF, cis and trans isomers) and dinitrogen tetrafluoride (F₂N−NF₂) in a mixture of nitrogen trifluoride (NF₃) and said at least one impurity. The present process may be used to treat nitrogen trifluoride mixtures containing any amount of at least one such impurity, for example, a nitrogen trifluoride mixture containing about two mole percent of at least one such impurity. The present process may be carried out in the presence of, and not detrimentally effected by, other impurities that may be present in nitrogen trifluoride mixtures such as nitrous oxide, carbon dioxide, sulfur hexafluoride, hexafluoroethane and tetrafluoromethane.

The present process involves a heating step where the nitrogen trifluoride mixture is heated in the gas phase. Heating the nitrogen trifluoride mixture may be carried out at a temperature of from about 150° C. to about 300° C., preferably from about 200° C. to about 250° C., and more preferably at about 235° C. The present inventors discovered that at such temperatures, the concentration of dinitrogen difluoride and dinitrogen tetrafluoride impurities in a mixture of such impurities and nitrogen trifluoride are reduced by the present process without significant decomposition and yield loss of nitrogen trifluoride to byproducts such as dinitrogen tetrafluoride. The present heating step may be carried out by heating a static nitrogen trifluoride mixture in a vessel, or more preferably, in a continuous process by heating a nitrogen trifluoride mixture as it flows through a vessel.

Various heating methods may be used to heat the nitrogen trifluoride mixture during the heating step, and heating methods are not particularly limited. The nitrogen trifluoride mixture may be heated in turn by externally heating the vessel with an electric heater or a burner, or by providing a jacket outside or within the vessel through which a heating medium may be circulated. Alternately, the nitrogen trifluoride mixture may be first heated to the desired temperature, then passed through or held in an insulated vessel for a period of time resulting in decomposition of the impurities and thereby the desired reduction in concentration of the impurities. For example, the nitrogen trifluoride mixture may be heated in a shell-in-tube type exchanger, then fed into a vessel such as an insulated pipe in which the nitrogen trifluoride mixture remains at the elevated temperature for the time required to reduce the concentration of the impurities. In an additional alternate configuration, the nitrogen trifluoride mixture may be brought to the desired temperature during the heating step by mixing the nitrogen trifluoride mixture with a heated carrier gas. For example, a nitrogen trifluoride mixture may be mixed with a nitrogen stream that has been heated, thus bringing the combined gas composition up to the desired heating step temperature.

In cases of both the vessel, of any gas distributor as may be optionally used, and of any preheater as may be optionally used, the undesirable decomposition of nitrogen trifluoride is reduced where the interior surfaces of the all components of the vessel contacting the nitrogen trifluoride mixture during the heating step are constructed from materials selected from the group consisting of electropolished metal, ceramic alumina and sapphire.

While increasing the temperature of the nitrogen trifluoride mixture, it is desirable that the temperatures of the vessel and process streams be limited so as to not promote the undesirable decomposition of nitrogen trifluoride. For example, where electric heaters are employed, low-heat-flux electric heaters are preferred to avoid extremely high surface temperatures, i.e., to avoid temperatures greater than about 300° C. Where other process fluids or a carrier gas is employed to heat the nitrogen trifluoride mixture, the temperatures of said process fluids and carrier gases are also preferably brought to temperatures no higher than about 300° C.

The contact time is the time for which the nitrogen trifluoride mixture is subject to the heating step. Contact time is not critical and is preferably selected so that nitrogen trifluoride product is obtained substantially free of both dinitrogen difluoride and dinitrogen tetrafluoride impurities, while suffering no or very little nitrogen trifluoride yield loss. The contact time at a given heating step temperature necessary to reduce the concentration of dinitrogen difluoride and dinitrogen tetrafluoride impurities in a nitrogen trifluoride mixture is dependent on the initial concentration of such impurities in the nitrogen trifluoride mixture and the desired final concentration of the impurities in the nitrogen trifluoride product. The contact time at a given heating step temperature necessary to reduce the concentration of impurities dinitrogen difluoride and dinitrogen tetrafluoride without decomposition of nitrogen trifluoride in a nitrogen trifluoride mixture may be determined by one of ordinary skill in the field to which this invention pertains without undue experimentation. Generally, the higher the initial concentration of the impurities, the longer the contact time a nitrogen trifluoride mixture needs to be held at an elevated temperature during the heating step and/or the higher the heating step temperature needs to be to reduce the concentration of at least one of impurities dinitrogen difluoride and dinitrogen tetrafluoride. Alternately, the lower the final concentration of impurities desired from any given initial concentration, the longer the contact time the nitrogen trifluoride mixture needs to be held at the elevated temperature during the heating step and/or the higher the heating step temperature that is needed.

For example, a nitrogen trifluoride composition containing varying amounts of dinitrogen difluoride is fed to a vessel at a rate of 0.45 kg (1 lb) per hour and at 101 kPa (1 atmosphere) pressure, where the composition is held at either 200° C. or 230° C. while passing through the vessel. Table 1 shows the vessel volume and contact time required to decrease the dinitrogen difluoride in the nitrogen trifluoride product to less than 5 ppm-molar.

TABLE 1

| | Vessel | Contact | Vessel | Contact |
|---|---|---|---|---|
| Inlet N₂F₂ | Volume | time | Volume | time |
| Concentration | @ 200° C. | @ 200° C. | @ 230° C. | @ 230° C. |
| (ppm-molar) | (m³ × 10⁻³) | (seconds) | (m³ × 10⁻³) | (seconds) |
| 10,000 | 9.97 | 235 | 0.991 | 23 |
| 1,000 | 7.99 | 189 | 0.793 | 19 |
| 100 | 3.99 | 94 | 0.396 | 9 |

The total pressure within the vessel during the heating step is not critical. To achieve commercially useful process productivity, and to move the nitrogen trifluoride mixture through the vessel during the heating step in a continuous process, the total pressure within the vessel during the heating step is preferably from about 101.3 kPa (1 atmosphere) to about 1,520 kPa (15 atmospheres). The total pressure within the vessel may be comprised entirely of the nitrogen trifluoride mixture, or may further comprise inert carrier gases that are unreactive with the components of the nitrogen trifluoride mixture, as well as easily seperable from the nitrogen trifluoride product. Such inert carrier gases include, for example, nitrogen, helium, carbon dioxide and hexafluoroethane.

The shape of the vessel in which the heating step is carried out is not critical. Any type of box, cylinder and the like vessel may be used. A cylindrical (e.g., tubular or pipe-type) vessel is preferred when the present process is carried out continuously. Although vessel shape is not critical, it is preferred that the ratio of the surface area of the vessel interior to the vessel volume be minimized in the regions of the vessel where the heating step is carried out. The preferred vessel configuration is a cylindrical vessel, and to minimize such a vessel's interior surface area to volume ratio, the vessel diameter is preferrably the largest diameter possible that still allows for adequate heat transfer across the vessel, i.e., the largest diameter possible that still allows for adequate heat transfer from nitrogen trifluoride mixture adjacent to the vessel wall to nitrogen trifluoride mixture at the center of the vessel. Where the nitrogen trifluoride mixture is passed through a cylinder of a given volume and said mixture is held at an elevated temperature, it is preferred that the cylinder be of a diameter and length that minimizes the cylinder interior surface area that the mixture comes in contract with. For example, if a flow-through reactor volume of 0.5 cubic meters is required to treat a nitrogen trifluoride mixture comprising nitrogen trifluoride and impurities dinitrogen difluoride and dinitrogen tetrafluoride, a reactor of 0.35 meter diameter, which would provide a internal surface area of 5.7 square meters, would be preferred over a reactor of 0.25 meter diameter, which would provide an internal surface area of 8.0 square meters.

So that the surface area of the vessel that the nitrogen trifluoride mixture comes in contact with during the heating step is minimized, it is preferred that the vessel is free of packing, i.e., no material be added as packing material to the vessel in the regions of the vessel where the heating step is carried out. If any such packing material is optionally added, preferably it is of a configuration such that its surface area is minimized. If a gas redistributor is used in the present vessel, it is preferably of a configuration minimizing its surface area. An example of a minimal surface area gas redistributor is a Kenics® Static Mixer. Further, such a gas redistributor preferably has a surface selected from the group consisting of electropolished metal, ceramic alumina and sapphire. Optionally, the surface of such a gas distributor may be passivated with a passivating composition comprising fluorine gas.

The mechanical preparation and smoothing of metal surfaces for industrial use can be divided into two stages: (i) “roughing down,” using grinding and abrasion techniques to produce a reasonably smooth and macroscopically plane surface, and (ii) “polishing,” using fine abrasives on polishing pads to give a microscopically smooth and bright surface. It is well established that such mechanical preparation leads to a severely deformed microscopic zone at the metal surface. This deformed zone has different properties from those of the bulk metal, and thus results obtained for operations carried out on or in the presence of mechanically polished surfaces are not characteristic of the bulk metal. Study of mechanically polished surfaces shows that the outer surface layer is an intensely deformed zone, and that the final, smooth, mechanically prepared surface is produced by a flow process, i.e., at a microscopic level, peaks in the metal are forced into hollows in the metal. A mechanically polished metal surface is thus a surface with a deformed zone comprising an abundance of undesirable microscopic scratches, strains, folds, metal debris and embedded polishing abrasives.

The term electropolished metal as used herein refers to metal that is made an anode in an electrolytic cell, and electrolysis is continued for a period of time sufficient to remove at least some of the deformed zone at the metal surface produced by any initial mechanical preparation and polishing. In order to produce the best electropolishing results, it is well known that the metal must be homogeneous and free from surface defects. Defects which are normally hidden by mechanical polishing may be revealed, and even exaggerated, by electropolishing. Inclusions, casting irregularities, seams, and the like will be eliminated if they are near the metal surface, but they are exaggerated if they lie at a critical distance from the surface. This critical distance is the average depth of metal removed by electropolishing. Without wishing to be bound by theory, it is believed that the surface cleaning and smoothing obtained by electropolishing a metal surface can be qualitatively accounted for by the differences in concentration gradient of a layer rich in metal-containing compounds that is formed over the microscopic peaks and valleys on the metal surface during electropolishing. At the metal peaks this layer is thin and the concentration gradient is higher, while in the metal valleys this layer is thicker and the concentration gradient is lower. During electropolishing, preferential solution of the metal peaks occurs and the surface is thus cleaned and smoothed.

The present process includes an embodiment where the heating step is carried out in the gas phase in a vessel with an electropolished metal inner wall. Metals of the present invention comprise metals that (i) are able to be electropolished, (ii) do not form volatile metal fluorides, and (iii) form metal fluorides that do not catalyze the thermal decomposition of nitrogen trifluoride. Metals of the present invention comprise aluminum, chromium, cobalt, copper, gold, iron, nickel, silver, tin, titanium, and zinc. Metals of the present invention further comprise alloys of the aforementioned metals, optionally further comprising the metal molybdenum, including, brass (comprising primarily copper and zinc), nickel silver, Monel® (comprising primarily nickel and copper), Hastelloy® (comprising primarily nickel, molybdenum and chromium), Inconel® (comprising primarily nickel, chromium and iron), Kovar® (comprising primarily nickel, iron, and cobalt), low and high carbon steels and stainless steel (comprising primarily iron, chromium and nickel). Preferred metals include nickel and metal alloys comprising nickel such as 316 stainless steel, Inconel®), Hastelloy® and Monel®).

The degree of surface roughness of electropolished metals may be described by the arithmetic mean roughness, Ra, expressed in microinches (or μm). This is the arithmetic mean of all profile deviations (metal trough depths and peak heights) with respect to the electropolished metal mean surface profile. For the embodiment of the present process where the heating step is carried out in a vessel with an electropolished metal inner wall, the inner wall may have an Ra value of about 70 microinches (1.75 μm) or less, preferably about 20 microinches (0.5 μm) or less, and most preferably about 10 microinches (0.25 μm) or less.

The present process includes an embodiment where the heating step is carried out in the gas phase in a vessel with an inner wall made of ceramic alumina. By ceramic alumina is meant a refractory material formed by firing a tightly packed powder form of Al₂O₃ which optionally includes some binder material, e.g., clay. Such ceramic alumina may be formed by heating alumina powders under pressure while in the desired shape to just under their melting point, a process called sintering. In forming ceramic alumina by sintering, matter from adjacent particles, under the influence of heat and pressure, diffuses to “neck” regions that grow between the particles and ultimately bond the particles together. As the boundaries between grains grow, porosity progressively decreases until, in a final stage, pores close off and are no longer interconnected. Alternately, such ceramic alumina may be formed by heating alumina powders to above their melting point and casting them into the desired shape. In either case, the ceramic alumina formed comprises a highly densified, solid, non-porous alumina surface. Suitable ceramic aluminas for the vessels of the current invention have densities of from 3.4 to 4.0 grams/cc, such as determined by ASTM method C20, herein incorporated by reference.

The present process includes an embodiment where the heating step is carried out in the gas phase in a vessel with an inner wall made of sapphire. By sapphire is meant a material comprising a single crystal aluminum oxide (Al₂O₃). Because it is a single crystal, sapphire cannot be molded, drawn or cast. It must be “grown” into a specific shape as dictated by the selected growth process. Synthetic, or man-made sapphire has the same single crystal rhombohedral structure as the natural gemstone, however, it is of a much higher purity and is water clear. While some crystal growth processes yield near net shapes, almost all sapphire components have to be fabricated from these shapes by various cutting, grinding and polishing operations. Sapphire is non-porous and does not absorb moisture.

The present process may optionally further comprise the step of contacting the inner wall of the vessel in regions where the heating step is carried out with a passivating composition comprising fluorine gas to produce a passivated vessel. If vessel passivation is carried out, it is preferably done prior to the heating step of the present process. Vessel passivation is carried out by contacting the inner wall of the vessel in regions where the heating step is carried out with dilute fluorine gas in an inert carrier gas, for example, 5 volume percent fluorine in helium or nitrogen. The dilute fluorine is contacted with the inner wall of the vessel at about ambient temperature (e.g., about 25° C.) and from about atmospheric to slightly elevated pressure (e.g., 55 kPa (8 psi)) for a period of time of about 30 minutes. The vessel may then optionally be brought to a slightly elevated temperature (e.g., 50° C.) and the inner wall of the vessel contacted with dilute fluorine for a period of time of about 12 hours. The vessel is then purged with pure inert carrier gas prior to beginning the present process heating step.

The present process reduces the concentration of at least one impurity selected from the group consisting of dinitrogen difluoride and dinitrogen tetrafluoride in a mixture of nitrogen trifluoride and said at least one impurity. Using a heating step temperature as defined herein and a sufficient contact time, the present process may produce a nitrogen trifluoride product that is substantially free of said at least one impurity. By nitrogen trifluoride product that is substantially free of said at least one impurity is meant that the nitrogen trifluoride product contains about 10 ppm-molar or less, preferably about 1 ppm-molar or less, and more preferably about 0.1 ppm-molar or less of said at least one impurity. Further, the present process produces said nitrogen trifluoride product with less than 2% yield loss of NF₃, most often less than 1% yield loss, most often less than 0.5% yield loss.

The nitrogen trifluoride product produced by the present process may be optionally further treated to remove the products of decomposition of the impurities dinitrogen difluoride and dinitrogen tetrafluoride. For example, the heating step of the present process may decompose the impurities dinitrogen difluoride and dinitrogen tetrafluoride into nitrogen and fluorine. The fluorine so produced may be removed from the nitrogen trifluoride product by known processes, e.g., by passing the product through an aqueous potassium hydroxide scrubbing solution, or through beds packed with alumina pellets, zeolite-based molecular sieves, or silica gel. The nitrogen so produced may be removed by known processes, e.g., by distilling the nitrogen trifluoride product, whereby the nitrogen is removed as an overhead product of the distillation and nitrogen trifluoride is recovered as a bottoms product.

### EXAMPLES

### EXAMPLE 1

Vessels (tubes) 0.491 cm internal diameter and externally heated zones 33 cm long (heated tube volumes of 9.61 cm³) comprised of carbon steel, non-electropolished 316 stainless steel, electropolished 316 stainless steel with Ra (surface roughness) of 15 microinches, electropolished nickel with Ra of 15 microinches, ceramic alumina, and sapphire were passivated by the following procedure. A gaseous mixture of 5 volume % fluorine in helium was added to a given tube at ambient temperature at a pressure of 8-10 psi. This gaseous mixture was immediately vented and the tube repressurized with fresh gaseous fluorine mixture and maintained at ambient temperature and 8-10 psi for 30 minutes. After this period, the tube was vented and repressurized to 8-10 psi with the gaseous fluorine mixture and the tube temperature maintained at 50° C. for eighteen hours. The tube was then cooled to room temperature and purged with nitrogen.

A gaseous stream of nitrogen trifluoride (NF₃) containing 448 ppm-molar dinitrogen difluoride (N₂F₂) and 356 ppm-molar dinitrogen tetrafluoride (N₂F₄) was fed to an otherwise empty tube. The nitrogen trifluoride was fed through the given tube at atmospheric pressure (101.3 kPa, 14.7 psia) and at a rate that provided contact times within the given tube heated zone ranging from 14 to 41 seconds. The product gas composition was monitored by a gas-chromatograph-mass-spectrometer and the results are given in Tables 2-7.

TABLE 2
Non-electropolished carbon steel tube, ppm-molar
concentration in off gas

| | | |
|---|---|---|
| 14 seconds | 28 seconds | 41 seconds |

| T (° C.) | N₂F₂ | N₂F₄ | N₂F₂ | N₂F₄ | N₂F₂ | N₂F₄ |
|---|---|---|---|---|---|---|
| 200 | 246 | 436 | 154 | 377 | 74 | 398 |
| 213 | 28 | 0 | 2 | 0 | 0 | 0 |
| 228 | 0 | 0 | 0 | 0 | 0 | 0 |
| 243 | 0 | 284 | 0 | 278 | 0 | 324 |

TABLE 3
Non-electropolished stainless steel tube, ppm-molar
concentration in off gas

| | | |
|---|---|---|
| 14 seconds | 28 seconds | 41 seconds |

| T (° C.) | N₂F₂ | N₂F₄ | N₂F₂ | N₂F₄ | N₂F₂ | N₂F₄ |
|---|---|---|---|---|---|---|
| 200 | 226 | 124 | 116 | 7 | 18 | 0 |
| 213 | 13 | 0 | 1 | 0 | 0 | 0 |
| 228 | 0 | 0 | 0 | 0 | 0 | 0 |
| 243 | 0 | 1 | 0 | 5 | 0 | 35 |

TABLE 4
Electropolished stainless steel tube, ppm-molar concentration
in off gas

| | | |
|---|---|---|
| 14 seconds | 28 seconds | 41 seconds |

| T (° C.) | N₂F₂ | N₂F₄ | N₂F₂ | N₂F₄ | N₂F₂ | N₂F₄ |
|---|---|---|---|---|---|---|
| 200 | 267 | 166 | 162 | 67 | 96 | 7 |
| 213 | 70 | 0 | 5 | 0 | 0 | 0 |
| 228 | 1 | 0 | 0 | 0 | 0 | 0 |
| 243 | 0 | 0 | 0 | 0 | 0 | 0 |

TABLE 5
Ceramic alumina tube, ppm-molar concentration in off gas

| | | |
|---|---|---|
| 14 seconds | 28 seconds | 41 seconds |

| T (° C.) | N₂F₂ | N₂F₄ | N₂F₂ | N₂F₄ | N₂F₂ | N₂F₄ |
|---|---|---|---|---|---|---|
| 200 | 260 | 89 | 120 | 0 | 12 | 0 |
| 213 | 26 | 0 | 3 | 0 | 1 | 0 |
| 228 | 1 | 0 | 0 | 0 | 0 | 0 |
| 243 | 0 | 0 | 0 | 0 | 0 | 0 |

TABLE 6
Sapphire tube, ppm-molar concentration in off gas

| | | |
|---|---|---|
| 14 seconds | 28 seconds | 41 seconds |

| T (° C.) | N₂F₂ | N₂F₄ | N₂F₂ | N₂F₄ | N₂F₂ | N₂F₄ |
|---|---|---|---|---|---|---|
| 200 | 270 | 141 | 145 | 0 | 15 | 0 |
| 213 | 85 | 0 | 4 | 0 | 1 | 0 |
| 228 | 2 | 0 | 0 | 0 | 0 | 0 |
| 243 | 0 | 0 | 0 | 0 | 0 | 0 |

TABLE 7
Electropolished nickel tube, ppm-molar concentration in off
gas

| | | |
|---|---|---|
| 14 seconds | 28 seconds | 41 seconds |

| T (° C.) | N₂F₂ | N₂F₄ | N₂F₂ | N₂F₄ | N₂F₂ | N₂F₄ |
|---|---|---|---|---|---|---|
| 200 | 252 | 118 | 163 | 21 | 91 | 7 |
| 213 | 101 | 0 | 20 | 0 | 4 | 0 |
| 228 | 6 | 0 | 0 | 0 | 0 | 0 |
| 243 | 0 | 0 | 0 | 0 | 0 | 0 |

As may be seen from the Table 2-7 data, increasing the heating step temperature reduced the amount of dinitrogen difluoride remaining in the nitrogen trifluoride gas. There are slight differences in efectiveness of the several tube materials of the present invention at the various temperatures, but overall they are very similar in ability to remove dinitrogen difluoride. As may be seen by comparing the data, the longer the contact time, the more effective the removal of dinitrogen difluoride from the nitrogen trifluoride gas.

The Table 2-7 data shows that at the lower temperatures tested, heating the nitrogen trifluoride gas stream in each of the several tube materials was also effective at removing dinitrogen tetrafluoride from the nitrogen trifluoride gas. However, at the higher contact time and higher temperatures, carbon steel and non-electropolished stainless steel begin to show increases in dinitrogen tetrafluoride concentration. The vessel materials of the present invention (i.e., electropolished stainless steel, electropolished nickel, ceramic alumina and sapphire) could be operated at the higher temperatures without degradation and yield loss of nitrogen trifluoride to additional undesirable dinitrogen tetrafluoride impurity.

It is known that nitrogen trifluoride reacts with certain metals at elevated temperatures to form dinitrogen tetrafluoride. Colburn, et al. in J. Am. Chem. Soc., Vol. 80, pg. 5004 (1958), discloses that nitrogen trifluoride reacts with copper, stainless steel, and other metals at elevated temperatures to give dinitrogen tetrafluoride in up to 71% yield. The present inventors accurately measured dinitrogen tetrafluoride in thermolyzed nitrogen trifluoride streams by gas-chromatograph-mass-spectrometer and determined that absence of dinitrogen tetrafluoride in thermolyzed nitrogen trifluoride streams in tubes with an inner wall selected from the group consisting of electropolished metal, ceramic alumina and sapphire indicates absence of nitrogen trifluoride yield loss by nitrogen trifluoride decomposition in the presence of such inner wall surfaces. The present inventors were able to corroborate such lack of nitrogen trifluoride yield loss by decomposition in the present process by infra-red spectroscopy. For example, pure nitrogen trifluoride was passed through a ceramic alumina tube at 243° C. for a contact time of 14 seconds, and it was determined using infra-red spectroscopy that the upper level of niotrogen trifluoride yield loss by decomposition of nitrogen trifluoride was 0.5%.

### EXAMPLE 2

A gaseous stream of nitrogen trifluoride (NF₃) containing 448 ppm-molar dinitrogen difluoride (N₂F₂) and 356 ppm-molar dinitrogen tetrafluoride (N₂F₄) may be fed to otherwise empty tubes of 0.491 cm internal diameter and externally heated zones 33 cm long. The resulting heated tube volumes will be 9.61 cm³. The tubes may be comprised of non-electropolished 316 stainless steel and electropolished 316 stainless steel with Ra (surface roughness) of 15 microinches. These tubes will not be passivated with a passivating composition comprising fluorine gas prior to treatment of a nitrogen trifluoride mixture. The aforementioned gaseous stream of nitrogen trifluoride containing dinitrogen difluoride and dinitrogen tetrafluoride will be fed to the tubes at atmospheric pressure (101.3 kPa, 14.7 psia) and at a rate providing contact times within the tube heated zone ranging from 14 to 41 seconds. The product gas composition will be monitored by a gas-chromatograph-mass-spectrometer and the results expected are reported in Tables 8 and 9.

TABLE 8
Non-passivated stainless steel tube, ppm-molar concentration in
off gas

| | | |
|---|---|---|
| 14 seconds | 28 seconds | 41 seconds |

| T (° C.) | N₂F₂ | N₂F₄ | N₂F₂ | N₂F₄ | N₂F₂ | N₂F₄ |
|---|---|---|---|---|---|---|
| 200 | 300 | 448 | 200 | 400 | 100 | 420 |
| 213 | 50 | 30 | 10 | 0 | 0 | 0 |
| 228 | 0 | 0 | 0 | 0 | 0 | 0 |
| 243 | 0 | 300 | 0 | 400 | 0 | 500 |

TABLE 9
Non-passivated electropolished stainless steel tube, ppm-molar
concentration in off gas

| | | |
|---|---|---|
| 14 seconds | 28 seconds | 41 seconds |

| T (° C.) | N₂F₂ | N₂F₄ | N₂F₂ | N₂F₄ | N₂F₂ | N₂F₄ |
|---|---|---|---|---|---|---|
| 200 | 230 | 150 | 150 | 20 | 30 | 5 |
| 213 | 20 | 0 | 3 | 0 | 0 | 0 |
| 228 | 0 | 0 | 0 | 0 | 0 | 0 |
| 243 | 0 | 0 | 0 | 0 | 0 | 0 |

What is claimed is:

1. A process for reducing the concentration of at least one impurity selected from the group consisting of dinitrogen difluoride and dinitrogen tetrafluoride in a mixture of nitrogen trifluoride and said at least one impurity, comprising:
heating said mixture at a temperature of at least about 150° C. in the gas phase in a vessel with an inner wall selected from the group consisting of electropolished metal, ceramic alumina and sapphire, and
recovering a nitrogen trifluoride product having reduced concentration of said at least one impurity.

2. The process of claim 1 wherein said heating is carried out at a temperature of from about 150° C. to about 300° C.

3. The process of claim 1 wherein said heating is carried out at a temperature of from about 200° C. to about 250° C.

4. The process of claim 1 wherein said heating is carried out at a temperature of about 235° C.

5. The process of claim 1 wherein an inert carrier gas is present with said mixture during said heating.

6. The process of claim 1 wherein said vessel is cylindrical.

7. The process of claim 1 wherein said vessel is free of packing.

8. The process of claim 1 wherein said inner wall of said vessel comprises electropolished metal selected from the group consisting of aluminum, chromium, cobalt, copper, gold, iron, nickel, silver, tin, titanium and zinc.

9. The process of claim 1 wherein said inner wall of said vessel is electropolished metal comprising nickel.

10. The process of claim 9 wherein said metal comprises Inconel®, Hastelloy® or Monel®.

11. The process of claim 1 w erein said inner wall of said vessel has an Ra value of about 70 microinches or less.

12. The process of claim 1 w erein said inner wall of said vessel has an Ra value of about 20 microinches or less.

13. The process of claim 1 w erein said inner wall of said vessel has an Ra value of about 10 microinches or less.

14. The process of claim 1 further comprising the step of contacting said inner wall of said vessel with a passivating composition comprising fluorine gas.

15. The process of claim 14 wherein said contacting is carried out at a temperature of about 25° C. and a pressure of about one atmosphere and said passivating composition comprises 5 volume percent fluorine in helium.

16. The process of claim 1 wherein said nitrogen trifluoride product contains about 10 ppm-molar or less of said at least one impurity.

17. A process for reducing the concentration of at least one impurity selected from the group consisting of dinitrogen difluoride and dinitrogen tetrafluoride in a mixture of nitrogen trifluoride and said at least one impurity, comprising:
providing a vessel the inner wall of which is selected from the group consisting of electropolished metal, ceramic alumina and sapphire,
forming a passivated vessel by contacting said inner wall of said vessel with a passivating composition comprising fluorine gas,
heating said mixture at a temperature of from about 150° C. to about 300° C. in the gas phase in said passivated vessel, and
recovering a nitrogen trifluoride product having reduced concentration of said at least one impurity.

18. A process for purifying a nitrogen trifluoride composition containing nitrogen trifluoride and at least one impurity selected from the group consisting of dinitrogen difluoride and dinitrogen tetrafluoride, comprising:
heating said nitrogen trifluoride composition at a temperature of from about 150° C. to about 30020 C. in the gas phase in a vessel with an inner wall of electropolished metal comprising nickel, and
recovering a nitrogen trifluoride product containing about 10 ppm-molar or less of said at least one impurity.

19. A process for purifying a nitrogen trifluoride composition comprising nitrogen trifluoride and at least one impurity selected from the group consisting of dinitrogen difluoride and dinitrogen tetrafluoride, comprising:
providing a vessel the inner wall of which is selected from the group consisting of electropolished metal, ceramic alumina and sapphire,
forming a passivated vessel by contacting said inner wall of said vessel with a passivating composition comprising fluorine gas,
heating said nitrogen trifluoride composition at a temperature of from about 150° C. to about 300° C. in the gas phase in said passivated vessel, and
recovering a nitrogen trifluoride product containing about 10 ppm-molar or less of said at least one impurity.

20. A vessel for the selective removal of impurities dinitrogen difluoride and dinitrogen tetrafluoride from nitrogen trifluoride, comprising a cylinder with first and second open ends and an inner wall selected from the group consisting of electropolished metal, ceramic alumina and sapphire, wherein said inner wall has been contacted with a passivating composition comprising fluorine gas.
